(19) United States
(12) Patent Application Publication
(10) Pub. No.: US 2007/0226226 A1
(43) Pub. Date: Sep. 27, 2007

(54) Method and system for distributing processing of computerized tasks

(75) Inventor: Itzhak Mintz, Kibbutz Dvir (IL)

Correspondence Address: NATH & ASSOCIATES, PLLC, Sixth Floor, 1030 15th Street, N.W., Washington, DC, 20005, US

(73) Assignee: ELTA SYSTEMS LTD., Ashdod (IL)

(21) Appl. No.: 11/386,870

(22) Filed: Mar. 23, 2006

(51) Int. Cl. G06F 17/30

(52) U.S. Cl. 707/10

(57) ABSTRACT

Methods and systems for distributing processing of computerized tasks from a client to one or more servers. One embodiment of the present invention describes producing task information and conveying the task information to a distribution processor. Another embodiment describes receiving inquiry data, retrieving from a repository task data indicative of a task that a specific server is competent to perform, producing data that is representative of the task data, and conveying the produced data to the specific server. Yet another embodiment describes obtaining competency data pertaining to tasks that a server can carry out and conveying the competency data to a distribution processor for receiving data representative of a task.

### FIELD OF THE INVENTION

This invention relates to distributing computerized tasks. More specifically, the invention relates to distributing computerized tasks from one or more clients to one or more servers.

### BACKGROUND OF THE INVENTION

Presently in the art efforts are being made in the field of distributing processing. For example, CORBA (Common Object Request Broker Architecture) is a standard developed by the OMG (Object Management Group) for distributing processing of applications over networks. CORBA applications are composed of objects, and typically, there are many instances of an object of a single type. For each object type, an interface is defined in OMG IDL (Interface Definition Language). In order to invoke the remote object instance, the client first obtains its object reference. An ORB (Object Request Broker) is an agent, providing the mechanisms by which objects transparently make requests and receive responses. The ORB can tell from an object reference that the target object is remote.

Other publications dealing with distributed processing are also available. For example, US 2003/158,887 discloses a distributed processing system, program product and method of executing a computer program distributed across a plurality of computers. First, interested participants register and provide a commitment for available excess computer capacity. Participants may enter a number of available hours and machine characteristics. A normalized capacity may be derived from the machine characteristics and a normalized excess capacity may be derived from the number of hours committed for the participant. New registrants may be assigned benchmark tasks to indicate likely performance. Parties may purchase capacity for executing large computer programs and searches. The computer program is partitioned into multiple independent tasks of approximately equal size and the tasks are distributed to participants according to available excess capacity. A determination is made whether each distributed task will execute within a selected range of other distributed tasks and, if not, tasks may be reassigned. The likelihood that a task will complete may be based on the participant's past performance. As each task is completed, the completing participant is checked to determine if the task is on schedule. Any task assigned to computers that are found to be behind schedule may be reassigned to other participants. A check is made to determine whether each task is assigned to at least one participant and several tasks may be assigned to multiple participants. Once all tasks are complete, the best result is selected for each task. Each participant may be compensated for normalized excess capacity and compensation and charges to requesting parties may be based on total available normalized capacity.

U.S. Pat. No. 6,463,457 describes a distributed computing platform using the idle computational processing power of a plurality of provider computers. At least one networked server collects tasks from client computers, schedules and distributes the tasks to networked provider computers, and collects and returns results to client computers. A client API forms tasks and collects results. In addition, according to U.S. Pat. No. 6,463,457 a compute engine operates on the provider computers to communicate with the server and execute tasks using idle computational power.

In the publications disclosed above knowledge of the server identity is required in order to distribute processing thereto. In addition, it is required to manage resources in the system. Hence, there is a need in the art for another distributed processing method, allowing distributing the processing of tasks without having prior knowledge of the servers' identities and without requiring management of resources in the system.

### SUMMARY OF THE INVENTION

It is therefore an object of the invention to provide a method and apparatus for distributing processing of tasks, wherein knowledge of the server identity is not required and wherein management of the system's resources is not required as well.

The invention provides a method for distributing processing of computerized tasks from a client to one or more servers, the method comprising:

obtaining data pertaining to a task;

producing task information representative of said data; and

conveying the task information to a distribution processor adapted to distribute processing of the task to the one or more servers.

The invention further provides a method for distributing tasks to one or more servers, the method comprising:

obtaining from one of said one or more servers inquiry data indicative of tasks that the respective server is ready to perform;

retrieving from a repository task data indicative of a task that a specific server of said one or more servers is competent to perform;

producing data that is representative of the task data; and

conveying to the specific server the data that is representative of the task data for enabling the specific server to carry out said task.

Still further, the invention provides a method for receiving data representative of tasks conveyed by a distribution processor to be carried out by a server, the method comprising:

obtaining competency data pertaining to tasks the server can carry out; and

conveying the competency data to a distribution processor for receiving data representative of a task, the data representative of a task enables the server to carry out said task.

The invention further provides a client agent for distributing processing of computerized tasks from a client to one or more servers, the client agent comprising:

a data obtaining unit adapted to obtain data pertaining to a task;

a task information producer coupled to said data obtaining unit, adapted to produce task information representative of said data; and

a distributor module for conveying task information representative of said data to a distribution processor adapted to distribute processing of the task to the one or more servers.

Further still, the invention provides a distribution processor for distributing tasks to one or more servers, the distribution processor comprising:

an inquiry data receiver adapted to obtain from one of said one or more servers inquiry data indicative of tasks that the respective server is ready to perform;

a task retriever adapted to retrieve from a repository that is adapted to store task data pertaining to various tasks to be performed by servers, task data indicative of a task that the one of said one or more servers is competent to perform;

a task representative producer adapted to produce data that is representative of the task data; and

a task representative transmitter adapted to convey to the one of said one or more servers the data that is representative of the task data for enabling the specific server to carry out said task.

The invention further provides a server adapted to receive data representative of tasks to be carried out therein from a distribution processor and carry out the tasks, the server comprising:

a server tasks manager adapted to obtain competency data pertaining to tasks one or more server processes can carry out and generate competency data representative thereof; and

a server agent coupled to said server tasks manager, the server agent is capable to convey the competency data to a distribution processor for requesting to receive data representative of a task, the data representative of a task enables a compatible server process to carry out said task.

In addition, the invention provides a program storage device readable by machine, tangibly embodying a program of instructions executable by the machine to perform a method for distributing processing of computerized tasks from a client to one or more servers, the method comprising:

obtaining data pertaining to a task;

producing task information representative of said data; and

conveying task information representative of said data to a distribution processor adapted to distribute processing of the task to the one or more servers.

The invention further provides a computer program product comprising a computer useable medium having computer readable program code embodied therein for distributing processing of computerized tasks from a client to one or more servers, the computer program product comprising:

computer readable program code for causing the computer to obtain data pertaining to a task;

computer readable program code for causing the computer to produce task information representative of said data; and

computer readable program code for causing the computer to convey the task information to a distribution processor adapted to distribute processing of the§ task to the one or more servers.

Still further, the invention provides a program storage device readable by machine, tangibly embodying a program of instructions executable by the machine to perform a method for distributing tasks to one or more servers, the method comprising:

obtaining from one of said one or more servers inquiry data indicative of tasks that the respective server is ready to perform;

retrieving from a repository task data indicative of a task that a specific server of said one or more servers is competent to perform;

producing data that is representative of the task data; and

conveying to the specific server the data that is representative of the task data for enabling the specific server to carry out said task.

Further still, the invention provides a computer program product comprising a computer useable medium having computer readable program code embodied therein for distributing tasks to one or more servers, the computer program product comprising:

computer readable program code for causing the computer to obtain from one of said one or more servers inquiry data indicative of tasks that the respective server is ready to perform;

computer readable program code for causing the computer to retrieve from a repository task data indicative of a task that a specific server of said one or more servers is competent to perform;

computer readable program code for causing the computer to produce data that is representative of the task data; and

computer readable program code for causing the computer to convey to the specific server the data that is representative of the task data for enabling the specific server to carry out said task.

Further still, the invention provides a program storage device readable by machine, tangibly embodying a program of instructions executable by the machine to perform a method for receiving data representative of tasks conveyed by a distribution processor to be carried out by a server, the method comprising:

obtaining competency data pertaining to tasks the server can carry out; and

conveying the competency data to a distribution processor for receiving data representative of a task, the data representative of a task enables the server to carry out said task.

The invention further provides a computer program product comprising a computer useable medium having computer readable program code embodied therein for receiving data representative of tasks conveyed by a distribution processor to be carried out by a server, the computer program product comprising:

computer readable program code for causing the computer to obtain competency data pertaining to tasks the server can carry out; and

computer readable program code for causing the computer to convey the competency data to a distribution processor for receiving data representative of a task, the data representative of a task enables the server to carry out said task.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIG. 1A is a block diagram depicting a system for distributing processing of computerized tasks, according to one embodiment of the invention;

FIG. 1B is a block diagram depicting the system of FIG. 1A in greater detail, according to one embodiment of the invention;

FIG. 2A is a flow diagram, illustrating a flow of distributing a task, according to the invention;

FIG. 2B is a flow diagram, illustrating another flow of distributing a task, according to the invention;

FIG. 2C is a flow diagram, illustrating an additional flow of distributing a task, according to the invention;

FIG. 3A is a flowchart illustrating the main operations performed by a client processor for distributing computerized tasks, according to one embodiment of the invention;

FIG. 3B is a flowchart illustrating in greater details operations performed by a client processor for distributing computerized tasks, according to one embodiment of the invention;

FIG. 4A is a flowchart illustrating the operations performed by a distribution processor upon obtaining task information, according to one embodiment of the invention;

FIG. 4B is a flowchart illustrating the operations performed by a distribution processor upon obtaining inquiry data, according to one embodiment of the invention;

FIG. 4C is a flowchart illustrating the operations performed by a distribution processor upon obtaining a status information item, according to one embodiment of the invention;

FIG. 5 is a block diagram depicting a server competent to carry out one or more kinds of tasks, according to one embodiment of the invention;

FIG. 6A is a flowchart illustrating the operations performed by a server process, according to one embodiment of the invention;

FIG. 6B is a flowchart illustrating the operations performed by a server tasks manager, according to one embodiment of the invention;

FIG. 7 is a block diagram depicting a client, according to one embodiment of the invention;

FIG. 8A is a block diagram depicting a distribution processor, according to one embodiment of the invention; and

FIG. 8B is a block diagram depicting a distribution processor, according to a different embodiment of the invention.

### DETAILED DESCRIPTION OF ILLUSTRATIVE EMBODIMENTS

In the following description components that are common to more than one figure will be referenced by the same reference numerals.

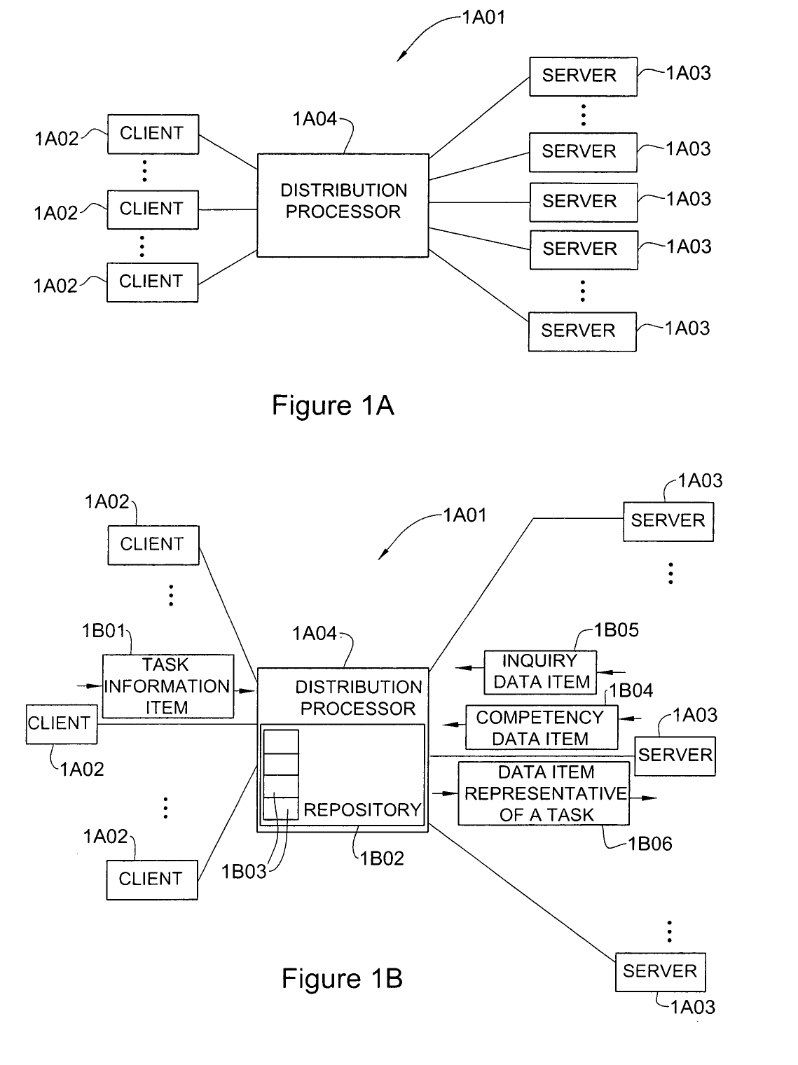

FIG. 1A is a block diagram depicting a system 1A01 for distributing processing of computerized tasks, according to one embodiment of the invention. In the system there are clients 1A02, wherein a client 1A02 is a processor requiring that one or more tasks be accomplished by other processors, called servers 1A03. The clients 1A02 and servers 1A03 are coupled to a distribution processor 1A04.

It is noted that the figure is a non-limiting example of a system 1A01 and hence the number of clients and number of servers is non-binding. In a system according to the invention there can be any number of clients and any number of servers. In addition, there is no correspondence between the number of clients and number of servers, and hence the system is considered as including at least one client and at least one server.

Even further, in the figure there is one distribution processor 1A04 illustrated. It should be appreciated that other embodiments wherein more than one distribution processor 1A04 exist are also covered by the invention. For example, in one such embodiment there can be two distribution processors 1A04, wherein one of them is active and the other is passive and used for redundancy, hence providing robustness to the system if the active distribution processor 1A04 fails, for example. According to a different example each one of the more than one distribution processors 1A04 can be responsive to tasks of a certain group of tasks, tasks originated from a certain group of clients (e.g., a segment in a network or a certain type of client) etc.

FIG. 1B is a block diagram depicting the system 1A01 of FIG. 1A in greater detail, according to one embodiment of the invention. In order to distribute a task to a competent server, a client 1A02 obtains information pertaining to a task and conveys the information in a task information item 1B01 to the distribution processor 1A04. Information carried by a task information client constitutes “task information”. The distribution processor, in turn, includes a repository 1B02, for storing task data items 1B03 pertaining to various tasks to be performed by servers. When the distribution processor obtains task information from a client, it stores a task data item 1B03 in the repository 1B02, the task data item 1B03 stores “task data” representative of the task information.

It is noted that each server 1A03 is competent to carry out one or more kinds of tasks. When a server 1A03 is ready to carry out a task, e.g., after completing processing a previous task, it obtains, or generates competency data pertaining to kinds of tasks the server is ready to carry out. Then the server 1A03 conveys the competency data “via a competency data item” 1B04 to the distribution processor 1A04.

It is noted though that the competency data does not necessarily pertain to all kinds of tasks that the server can carry out. For example, a server is competent to carry out four different kinds of tasks; three thereof require greater resources (e.g., memory and CPU processing time) than the fourth. When the server has enough resources available for carrying out a task of the fourth kind, resources that do not suffice for the other three kinds, it can convey to the distribution processor 1A04 competency data pertaining to the fourth kind alone.

Alternatively, a server 1A03 can convey to the distribution processor 1A04 a competency data item 1B04 upon startup, and/or whenever a new kind of task is introduced to the server. When the server is ready to handle one or more kinds of tasks, it can send an inquiry data item 1B05 to the distribution processor 1A04 (the inquiry data item carries “inquiry data”), instead of competency data, wherein the inquiry data is indicative of the server's availability and hence can be used for inquiring whether the distribution processor is aware of any competent task that can be relayed to the server. It is noted that in a server competent to carry out only one kind of task, for example, the inquiry data is not required to identify the task's kind, which is known to the server further to receiving the competency data. Hence, the term “inquiry data” is used to describe data conveyed from a server to the distribution processor for indicating it is available to carry out a task, while according to some embodiments, competency data can be used as inquiry data.

Upon receiving inquiry data 1B05 from a server 1A03, the distribution processor 1A04 retrieves from the repository 1B02 task data indicative of a task that the server is competent to carry out, based on the server's competency data and/or inquiry data. Then the distribution processor conveys data item 1B06 that is representative of the task data to the server, hence enabling it to carry out the task.

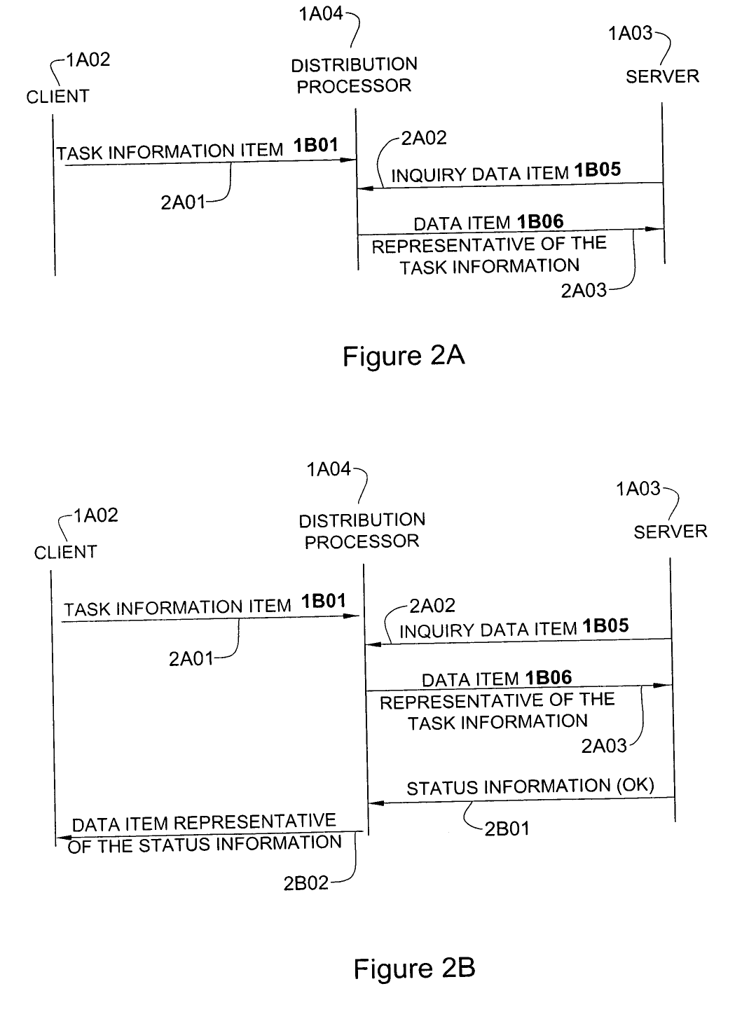

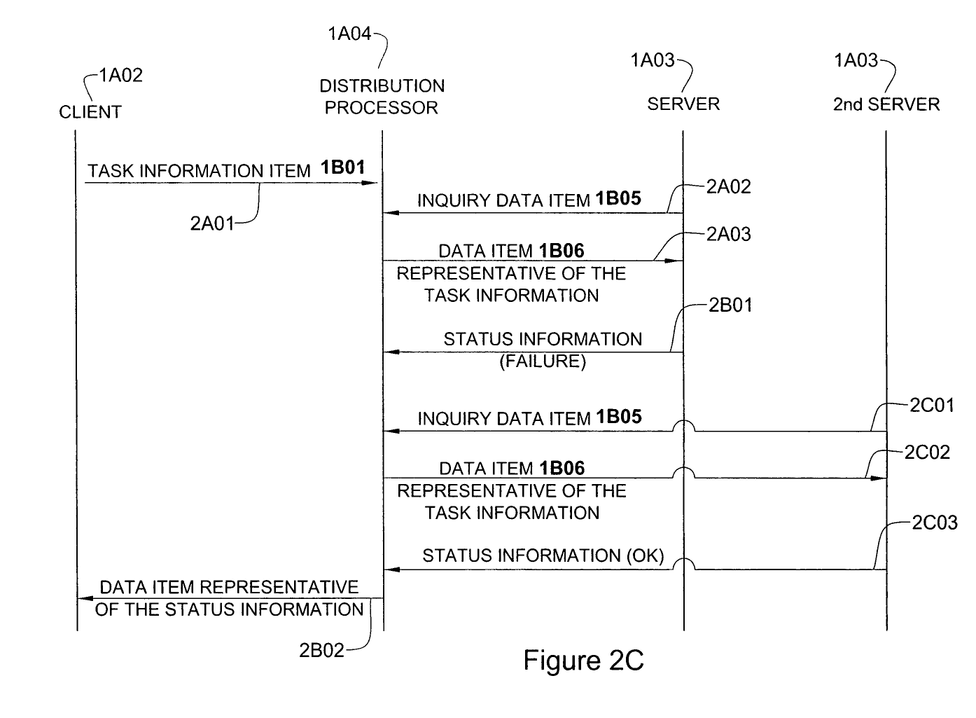

FIG. 2A is a flow diagram, illustrating a flow of distributing a task, according to the invention. The flow diagram depicts flow between three tiers: a client (such as client 1A02), a distribution processor (such as distribution processor 1A04) and a server (such as server 1A03). According to the invention on 2A01 the client conveys task information (such as task information 1B01) to the distribution processor. Upon receiving 2A02 inquiry data (such as inquiry data 1B05) from a server, wherein the received inquiry data pertaining to tasks of the task information's kind, on 2A03 the distribution processor conveys to the server data 1B06 representative of the task information. It is noted that upon receiving the data 1B06 the server can accomplish the task.

According to other embodiments a server (1A03) can convey to the distribution processor status information indicative of the task accomplishment's status, as illustrated in FIG. 2B. Upon receipt 2B01 of such status information, if the information indicates that the server 1A03 has accomplished the task, the distribution processor 1A04 conveys 2B02 data representative of the status information received on 2B01 to the client 1A02.

However, if the status information received on 2B01 indicates that the server failed to accomplish the task, instead of transmitting an indication thereof to the client, as illustrated in FIG. 2B, the distribution processor 1A04 can wait for other inquiry data 1B05, from a second server 1A03 competent to accomplish the task. Upon receipt 2C01 of such inquiry data, the distribution processor conveys 2C02 to the second server data 1B06 representative of the task information received on 2A01. Upon receiving (on 2C03) indication that the second server had accomplished the task, the distribution processor conveys (on 2B02) to the client data representative of the status information received on 2C03, as illustrated in FIG. 2C.

It is noted that the flow diagrams illustrated in FIGS. 2A, 2B and 2C are non-limiting and other embodiments, allowing different flows, exist. For example, according to one such alternative embodiment, instead of waiting until status information is received (e.g., see 2B01 and 2C01), the distribution processor can convey to servers requests for data indicative of their status of accomplishing a task. Yet, this is non-limiting as well and combinations are allowed too. For example, a distribution processor can follow the flow of FIG. 2A with regard to a first item of task information, the flows of FIGS. 2B and 2C with regard to a second item of task information, while regarding a third item of task information it can convey to the client information representative of status information even in those cases when the status information includes indication of failure. Even further, a server can send a response, or reply, to a client via the distribution processor. Hence, for example, if a client needs to sort several numbers included in a set of numbers, the task information can include identification of the task kind (which is “sort” according to the example) and the numbers included in the set. A server competent to perform sorting tasks, further to sending inquiry data to the distribution processor, receives data representative of the task therefrom (in this example the data includes a task identification, task kind identification such as “sort”, and the numbers), sorts the numbers, and sends a response to the distribution processor, wherein the response includes the task's identification and the numbers, now appearing in accordance with the sorted order. Data representative of the response is then sent by the distribution processor to the client. The server can also store the sorted numbers in a file and send to the distribution processor a response including identification thereof, wherein the client is able to access the file directly, etc. Still further, in a different embodiment, a client can convey status inquiry to the distribution processor, wherein responsive thereto the distribution processor conveys data representative of status information to the client. It is appreciated that in this case the data item representative of the status information can include a “still waiting” indication, being indicative that the server did not convey status information yet. Understanding this is it appreciated that many nuances exist and hence other applicable embodiments are covered by the present invention.

Yet, according to another embodiment, the data representative of a task can include an indication of the identity of the client, such as its IP (Internet Protocol) address or any other identification information. According to this embodiment the server, after receiving the data representative of a task can connect to the client directly, without the mediation of the distribution processor. Such communication between a server and a client (without the mediation of a distribution processor) constitutes “direct communication”, while it is appreciated that using direct communication the server can, for example, convey status information directly to the client, or alternatively request to receive additional information required for the accomplishment of a task.

It is noted that according to the invention, in order to receive and/or convey task information items (see, for example, 2A01), inquiry data items (see, for example, 2A02), data items representative of tasks (see, for example, 2A03), status information items (see, for example, 2B01 and 2C03), data items representative of status information (see, for example, 2B02) etc., clients and servers need to have agents installed therein. Agent are used in prior art, e.g., in CORBA (Common Object Request Broker Information), where they are referred to as “ORBs” (Object Request Brokers). However, in CORBA a client's ORB needs to have information about the identity of servers, as there are no mediators that are equivalent to the distribution processor. Similarly, the server's ORB needs to have information about the identity of the client, in order to return status information or any other response thereto. Contrary to CORBA, an agent in accordance with the present invention, having a distribution processor 1A04 as mediator, needs no information relating to identities of servers and clients. Clients send task information to the distribution processor and receive status information therefrom, while servers send inquiry data and other items to the distribution processor while they receive data representative of task information etc. therefrom. It should be appreciated that similar to CORBA, an agent in the present invention can operate as a process (or processor) accessible to client applications and/or server applications. However, in other embodiments of the invention an agent can be a section of computer code being part of a client application and/or server application and activated thereby, such as a function that the client and or server can call.

Furthermore, because clients (client processes and client agents) send task information items to the distribution processor, they do not need any information about the availability of servers. Hence, if, e.g., there are several servers competent to accomplish a task, the client does not need any information about which one of the competent servers is available and which one is busy. The client's agent always sends the task information to the distribution processor. Further still, it should also be appreciated that the distribution processor does not require information about the identity and availability of servers. A server application that is available to accomplish a task addresses the distribution processor (via an inquiry data item sent by the server's agent) and inquires whether a competent task is waiting therein. This feature allows the system 1A01 to be dynamic, wherein clients (client agents and/or client processes) and/or servers (server agents and/or server processes) can join the system or leave it at any time.

The invention also facilitates management of systems competent to processing heavy duty tasks, such as image processing and/or heavy statistical analysis. In such systems servers can be heavily loaded while processing one or more tasks, thus rendering them unavailable for processing additional tasks. However, in accordance with CORBA, for example, the client doesn't have information pertaining to the server's availability, and hence a long wait is sometimes necessitated until the task's processing is accomplished. Alternatively, the CORBA client needs to obtain information from the server on its availability status before requesting it to accomplish a task.

In addition, US 2003/158,887, for example, describes a method for coping with availability, wherein participants in the distributed processing system commit to provide certain excess computer capacity while registering to the system. According to US 2003/158,887 tasks are distributed to participants according to available excess capacity, which means that capacity management is required. It is noted that unlike US 2003/158,887 the present invention requires no availability or capacity management.

Similarly, U.S. Pat. No. 6,463,457 describes a distributed computing platform wherein a centralized task server takes all incoming tasks and pools them in some priority order, validates each one of them and assigns them to one or more compute engines, based on information on available provider computers and their characteristics. That means that U.S. Pat. No. 6,463,457 also requires to manage information pertaining to servers and their respective availability. In addition, the centralized task server of U.S. Pat. No. 6,463,457 requires familiarity (knowledge) with information pertaining to the tasks, in order to validate the information and assign it to compute engines. Unlike U.S. Pat. No. 6,463,457, the present invention needs no knowledge about the information pertaining to the task, apart from their type. This allows even greater dynamics of system 1A01, as it allows adding and removing new task types at runtime.

It was noted before that tasks of different kinds can be distributed in accordance with the invention. According to one embodiment of the invention each task kind is identified by a unique kind identification included, for example, in the task information and in the competency data and/or inquiry data. Task identification can be a string (like the “sort” example provided above), a kind identification number, a user defined data type or any other identification method, hence the general term “task kind identification object” is used. In addition, clients and servers need to be synchronized while identifying tasks' kinds, e.g., by using a “map file”, for mapping content of task kind identification objects to task kinds.

Apart from task kind identification, each task information item can receive, for example, an identification number, serving to uniquely identify the item in the agent or in the system. In order to distinguish this identification number from the “task kind identification”, it is referred to, hereinafter, as a “task identification”. It is to be noted that the task identification is not necessarily a number, as it can be any other object, as previously explained with reference to the task kind identification. Furthermore, if the task identification is used internally by the agent, the agent can manage the identification objects it uses for identifying task information items. However, if the task identification is used in order to uniquely identify a task in the system a centralized management is required therefor. One way of allowing central management of task identification is handled by the distribution processor. The distribution processor can allocate identification objects (wherein each identification object is unique) and convey the objects (or their content) to the agents (clients and servers), so they can identify tasks therewith. According to this embodiment the agents can request receiving an identification object from the distribution processor whenever a new task information item is produced. However, the agents can also request to receive a set of identification objects, storing them for later use. Upon producing a task information item the agent associates therewith (e.g., includes in a predetermined field in the header) one of the stored identification objects, and removes this object from the set. When the set becomes empty (or almost empty), the agent can request another set of identification objects and so on.

An alternative method can bypass the requirement of having a centralized management of identification object management. For example, an identification object can include a number and a unique identifier of the agent where the task information was produced. The unique identifier can be a unique number identifying the agent or even a string such as the agent's processor MAC (Media Access Control) address. As each processor has a unique MAC address, as long as there is no more that one agent operating on a processor, the MAC address can uniquely identify the agent. Then, by providing agent-unique number and associating the number with the MAC address, the couple can be used as a system unique identification object (even though two agents might provide two identical numbers).

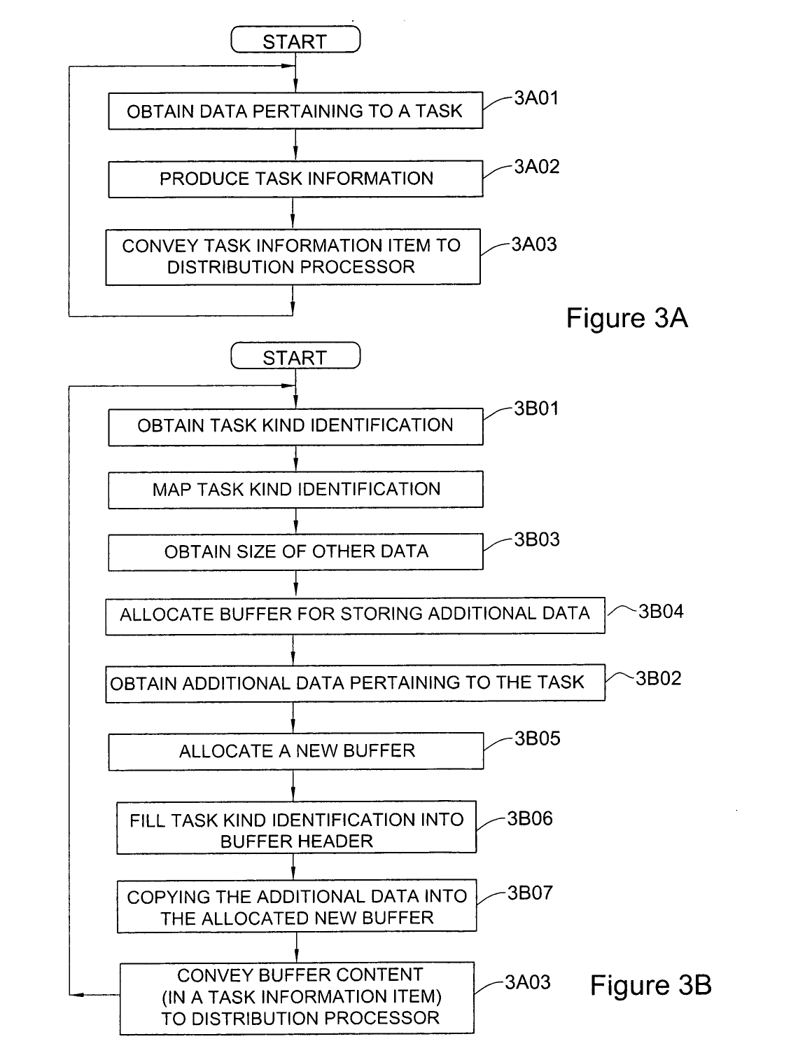

Furthermore, there are provided several embodiments, illustrating how the invention can be carried out. For example, FIG. 3A is a flowchart illustrating the main operations performed by a client agent (such as the client agent coupled with the client 1A02) for distributing computerized tasks, according to one embodiment of the invention. According to the embodiment, in 3A01 an agent operating as a client in the system 1A01 obtains data pertaining to a task from client process accessible thereto. It is noted that the data can include, for example, identification of the task kind and any additional data required for the accomplishment of the task. Upon obtaining data in 3A01, the agent produces in 3A02, or in other words generates task information representative of the data, and it conveys the task information (in 3A03) to a distribution processor (such as distribution processor 1A04). It should be realized that according to the embodiment, after conveying the task information in 3A03 the agent is ready to obtain additional data.

For example, a client process is a router processor (shortly referred to as a “router”) connected to a communication network. The router collects information respective of routed traffic in a database and it requires that a remote server, having access to the collected information, statistically analyses the information, thus allowing enhancements to the network management. In order to have access to the collected information, the remote server must receive, for example, access to tables in the database where the information is stored (such as database identification, table identification and keys) or alternatively the router can copy the collected information into a buffer accessible to the remote server, such as a network buffer. In order to distribute the statistical analysis task to a remote server, the router conveys data pertaining to the analysis task to an accessible agent, operating in accordance with the invention. According to this example the data includes database identification, table identification and keys and possibly also identification of the required task kind. Alternatively the data can include a copy of the collected information with or without identification of the required task kind. It is noted that task kind identification is not required wherein all the remote servers can accomplish only statistical analysis tasks of the required kind. It is further noted that the router can convey the information to the agent using a stream, for example, such as by streaming the information via a communication line. Alternatively it can convey the information using any other available interface, such as shared memory, function calls etc. Even further, the information can be conveyed at once (e.g., by streaming the database identification, table identification and keys using one buffer, or by using three parameters in a function call) or in pieces, such as conveying the database identification in one function call, the table identification in a second function call, and the keys in a third function call. The database identification, table identification and keys, together with the task kind identification (if required) form, according to the example, data pertaining to the task. In the alternative, wherein copy of the collected information is conveyed, the data pertaining to the task includes the copy of the collected information together with the task kind identification (if required).

Upon receiving the data, the client agent produces a task information item representative of the data pertaining to the task, wherein the task information item includes task information. It is noted that according to one example, wherein the agent conveys the received data without any manipulation, the task information can be the received data itself or a copy thereof. That is, “representative” also includes the case where the task information item is constituted by the same data that the client agent receives. Yet this is not mandatory, as those versed in the art would appreciate that the agent can manipulate the data pertaining to the task before conveying it to the distribution processor, e.g., by encrypting it, compressing it, copying it, arranging it in any applicable data structure or performing any other manipulation thereon. Hence “representative” can include any manipulation applied to the data, as long as the task information item includes task information from which it is possible to identify the task kind (in those cases when task kind identification is required) and any other information required for carrying out the task (as long as this information was available to the client's agent). For example, according to one embodiment, wherein the agent has no knowledge about the data pertaining to tasks distributed thereby, the agent can obtain task kind identification together with data stored in a buffer whose length is known. Such an agent can copy the data in network order into a second buffer (such as a network buffer), write the task kind identification or alternative data representative thereof (such as data received by mapping the received task kind identification) into a predetermined position in the buffer, constituting part of a “header”, and convey the data stored in the buffer to the distribution processor, e.g., by transmitting it via a communications network.

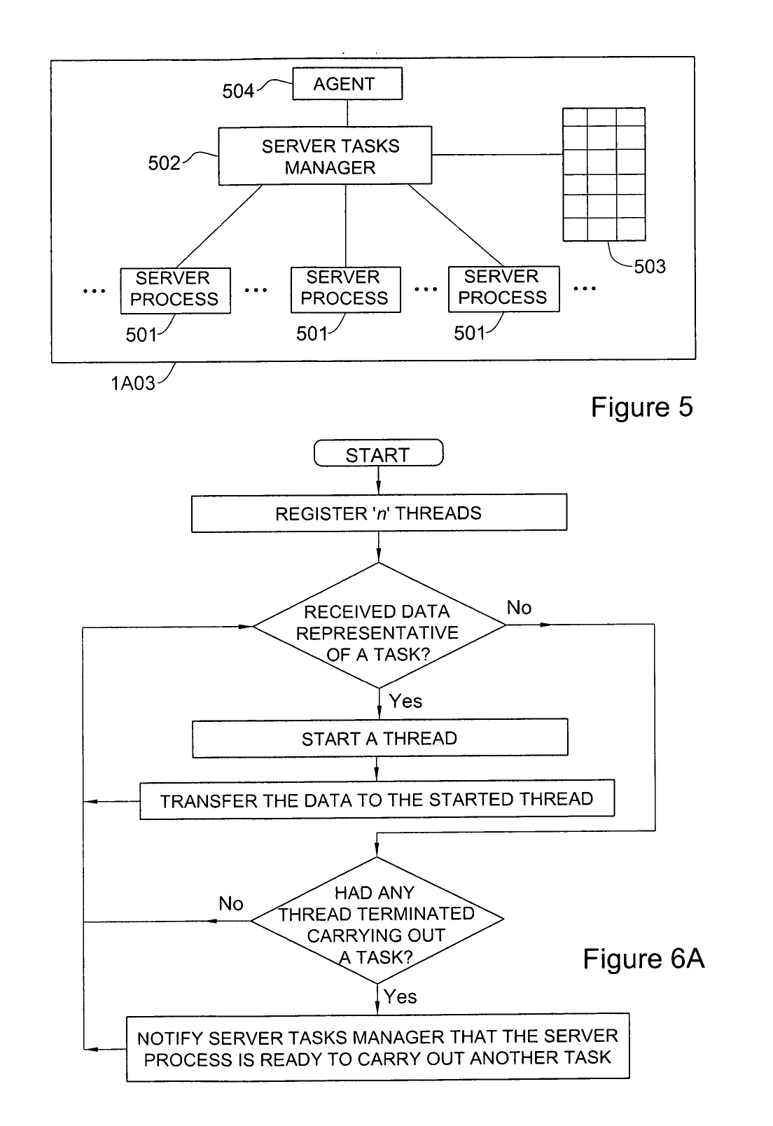

It is noted that an agent operating in accordance with the latter example needs no knowledge about the data and/or task information, possibly apart from the task kind identification. Furthermore, such an agent needs to know nothing about the identity of the remote server (neither server application nor server agent, see for example FIG. 5 below) that accomplishes the task as the data is conveyed to the distribution processor.

FIG. 3B is a flowchart illustrating in greater details operations performed by a client processor for distributing computerized tasks, according to one embodiment of the invention. According to this embodiment, obtaining data pertaining to a task (see 3A01 in FIG. 3A) includes obtaining task kind identification in 3B01 and obtaining additional data pertaining to the task in 3B02. In the “router example” described above, the task kind identification can be, e.g., the string “statistical analysis” or a number mapped for the task kind. The additional data can include the database identification, table identification and keys. According to the example, the agent neither has knowledge about the data obtained in 3B01 and 3B02 nor about the conveyed task information, and hence, according to the example, it obtains (in 3B03) the size of the additional data, allowing it to allocate a buffer large enough for storage thereof in 3B04. In this case, the additional data obtained in 3B02 is stored in a buffer allocated in 3B04.

According to the figure, producing a task information item (see 3A02 in FIG. 3A) includes allocating (in 3B05) a new buffer for the task information item, wherein the size of the new buffer according to the example is the size of the additional data (previously obtained in 3B03) together with a predetermined size of a header characteristic of task information items according to the embodiment. Producing the task information item includes also filling the task kind identification into the header, as indicated in 3B06 (those versed in the art would appreciate that the header can include also information corresponding to the new buffer size), and copying the additional data into the allocated new buffer, possibly in a network order. See 3B07. To this end the new buffer and the information stored therein constitutes a task information item, which the agent conveys in 3A03 to the distribution processor.

It is noted though that the embodiment illustrated in FIG. 3B is non-limiting and alternative embodiments are allowed if applicable. For example, one such embodiment allows the agent to have knowledge about the tasks distributed thereby. Such an agent can have an interface (such as function calls) allowing it to obtain additional data as values of parameters. It is possible to define the interface of such an agent using Interface Definition Language (IDL), as done, for example, in CORBA. In addition, the information stored in a task information item is not limited by the embodiment. For example, one alternative embodiment can include a task identification object in the task information item (e.g., in its header), allowing the agent to match responses and status information (if available) with the task information. See, for example, 2B02 in FIGS. 2B and 2C.

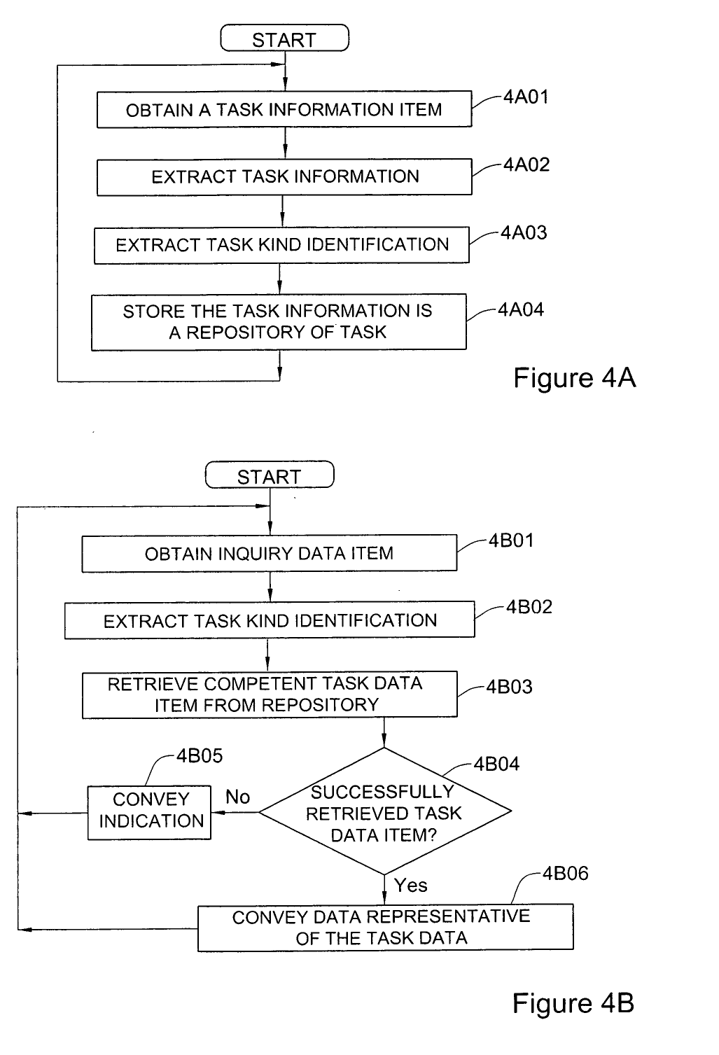

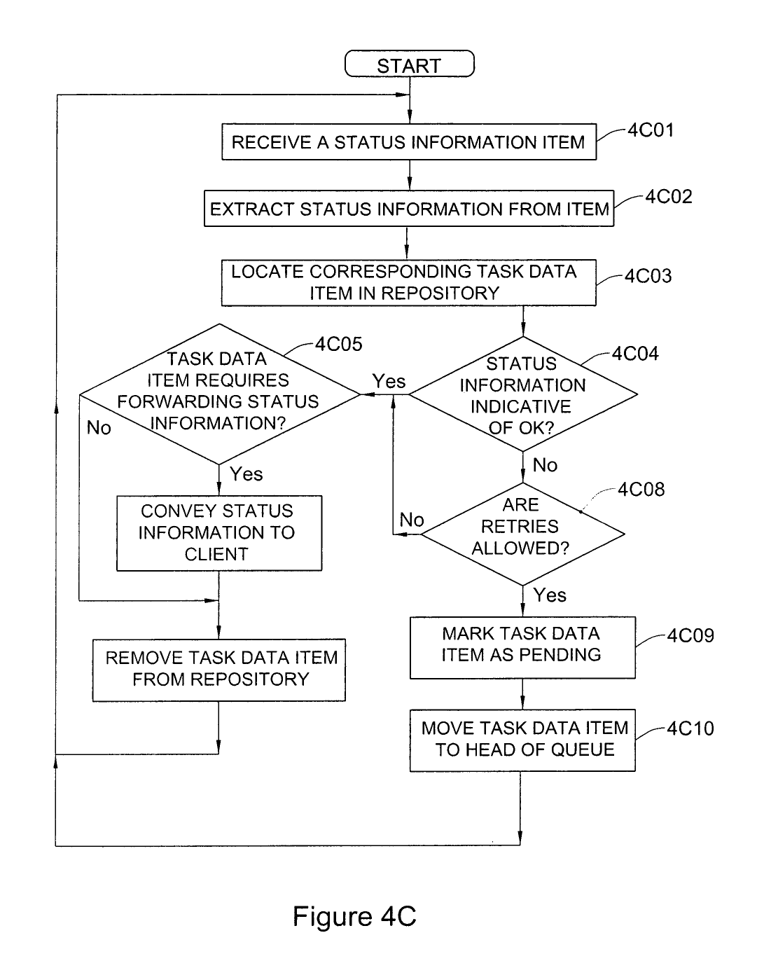

Having understood how a client agent can convey task information items to the distribution processor, FIG. 4A provides a flowchart illustrating the main operations performed by a distribution processor (such as 1A04) upon obtaining task information, according to one embodiment of the invention. According to the embodiment, upon obtaining a task information item from a client in 1A01, the task information is extracted therefrom (see 1A02), as well as the task kind identification (see 1A03). Then, in 1A04, a task data item representative of the task information (the task data item can be a copy of the task information item or the result of manipulating the task information carried therewith) is stored in a repository of tasks, such as 1B02 in FIG. 1B. The repository of tasks can be a table (or tables) in a database. Alternatively the repository of tasks can be any other form of repository, such as a data structure stored in memory, e.g., a hash table, etc. However, it should be appreciated that the repository of tasks should allow retrieval of task data therefrom, wherein the task kind identification is used as a key.

While storing task data items, according to one embodiment, the distribution processor can store in association with each item an identification object used for identification. The identification object can be similar to the identification object.

It was mentioned before, e.g., with reference to FIG. 1B, that when a server is ready to accomplish a task, it conveys an inquiry data item (including inquiry data) to the distribution processor. FIG. 4B is a flowchart illustrating the main operations performed by a distribution processor (such as 1A04) upon obtaining inquiry data 4B01, according to one embodiment of the invention. It was previously explained that the inquiry data is indicative of tasks the server is ready to accomplish. Hence, further to extracting the task kind identification from the inquiry data in 4B02, in 4B03 the distribution processor retrieves a competent task data item (i.e., task data having the same task kind identification as the inquiry data) from the repository of tasks. It is appreciated that the repository might include no task data having competent task kind identification, in which case the retrieval returns nothing or fails (for example, it can return a known per se NULL value). Hence in 4B04 the distribution processor checks the result of the retrieval operation 4B03. If the result indicates that the repository includes no competent task data item, in 4B05 the distribution processor operating in accordance with the invention conveys an indication of failure to the server who sent the inquiry data, thus releasing it to accomplish other tasks, such as tasks belonging to other task kinds or tasks that do not arise from system 1A01. Yet, if the distribution processor successfully retrieves task data from the repository, in 4B06 the distribution processor conveys data representative of the task to the server.

It is noted that the data representative of the task is carried by a data item representative of a task (see, e.g., 1B06 in FIG. 1B), while the data representative of the task can be identical to the task data, a copy thereof, or the result of any manipulation applied thereto. In addition, the data item can have a task identification object associated therewith (e.g., stored in a predetermined field of the data item's header). If the task data item (the one stored in the repository) has a task identification associated therewith the data item representative of a task can have the same task identification. Alternatively the distribution processor can produce a new task identification, store it in association with the task data item (e.g., in a predetermined field dedicated therefore) and copy the task identification to the data representative of the task, before conveying it to the server. Hence, if the distribution processor receives a status information (such as the FAILURE 2B01 and OK 2C03 illustrated in FIG. 2C), it can associate the indication with the task data item, thus re-sending it to a different server (see 2C02 in FIG. 2C) or forwarding the status information to the client's agent (see 2B02 in FIGS. 2B and 2C).

FIG. 4C is a flowchart illustrating the operations performed by a distribution processor upon obtaining a status information item, according to one embodiment of the invention. According to this embodiment, the distribution processor forwards status information to the clients only upon the clients' request. That is, the task information item as the task data item have fields in their headers indicative of whether status information should be forwarded or not. In addition, it was previously illustrated in FIG. 2C, that the distribution server can re-assign a task to a second server, upon failure of a first server (see, e.g., 2B01, 2C01 and 2C02). The present embodiment allows the distribution processor to re-assign a task a predetermined number of times, following which a failure indication is sent to the client. The predetermined number of times can be a parameter characterizing the distribution processor, however, any alternative is applicable, such as storing the predetermined number in the task information item (e.g., in the header), thus allowing the client's agent to affect the number of re-tries.

Upon receiving a status information item on 4C01, the distribution processor extracts (on 4C02) the status information therefrom and locates (on 4C03) the task data item corresponding to the status information in the repository of tasks. It is to be noted that in 4C03 the distribution processor can use the task identification in order to locate the task data item. Alternatively it can use other information such as the time on which that data item representative of the task information was conveyed to the server together with the server's identity (if those are listed in the status information item) etc.

Upon locating a task data item, on 4C04 the distribution processor checks the extracted status information, for verifying whether it is indicative of “OK” (that is, whether it indicates that the server accomplished the task successfully), and if so, it checks (on 4C05) whether the client requires that status information is redirected (or forwarded) thereto. If required, the status information is redirected to the client's agent on 4C04. It is noted though, that the distribution can direct the status information itself, or any other information representative thereof. Furthermore, the distribution processor can forward, at the same time, status information corresponding to more than one task (e.g., it can forward a list of statuses corresponding to several tasks, wherein such a list can be conveyed to the client's agent once in a predetermined time period), or it can forward the status information of a single task upon the receipt thereof, as illustrated in the present embodiment. In 4C07 the task data item is removed from the repository of tasks.

However, the present embodiment supports also the possibility of receiving a status information indicating that the server failed to accomplish a task, as detected in 4C04. In this case, if on 4C08 it is determined that re-tries are allowed (that is, the distribution processor can wait for another inquiry data item, from a different server competent to carry out the task), in 4C09 the task data item in the repository is marked as pending, and if there is a queue of tasks of its kind it may be moved to the head of the queue on 4C10. It should be understood that upon receiving an inquiry data item from a server competent to carry out the task, it will be distributed thereto, e.g., in accordance with FIG. 4B.

It is noted that sometimes the distribution server requires to distribute tasks to server, e.g., tasks allowing management thereof, tasks allowing the repository content to be persistent (thus requiring backup of the task data stored therein) etc. Hence, returning, e.g., to 4A01 in, FIG. 4A it should be appreciated that obtaining task information can include generating the task information. That is, the distribution processor in this case is also a client, hence it generates task information (as a client), but instead of conveying it to the distribution processor, i.e., to itself (see, e.g., 3A03 is FIG. 3A), the generated task information (which is already in the distribution processor) is used for production of task data representative thereof, which is further stored in the repository.

Further to the illustrated embodiments allowing operation of a distribution processor, a server (such as 1A03 in FIGS. 1A and 1B) is now described, with reference to FIG. 5. In the illustrated embodiment the server sends to the distribution processor inquiry data, which is also competency data. Yet, this is not-limiting, and as was previously noted, as there are situations in which the competency data can be separated from the inquiry data, e.g., in those cases when the server is competent to carry out only one kind of tasks. According to a different example, upon startup the server can convey competency data indicative of all the task kinds it can potentially carry out, while whenever it is ready to carry out tasks of at least one kind, it conveys thereto inquiry data indicative only of the kinds it is ready to carry out.

In the illustrated embodiments it is assumed that different kinds of tasks are accomplished by different processes (also applications or processors) operating in the server. Each process, constituting a “server process” 501, has a predetermined identification (e.g., an identification number, an identification string, or generally, an identification object), used by a server tasks manager 502 to identify task kinds that the server is able to carry out. According to the example, when installing on a computer program that is designed to operate as a server process in the system 1A01, the predetermined identification is given, or allocated thereto by the administrator or by any other person who installs the software. According to the embodiment the predetermined identification is listed in a server tasks identification table 503 used for mapping the task identification to the respective task kind. It is noted that while the task kind is global to the system 1A01, wherein tasks of the same kind are identified by a task kind identification familiar to the distribution processor and to other clients and/or servers operating in the system, the predetermined identification is local to the computer and hence there is no requirement (according to the present embodiment) that it will be familiar outside therefrom. Even further, it was previously noted that the predetermined identification is given to a server process upon installation, yet alternative embodiments can allocate a predetermined identification for a process upon startup: the server process can register in the server tasks manager, identifying the tasks it can carry out, thus receiving the predetermined identification therefrom. The task manager, in turn, lists the predetermined identification in the server tasks identification table, mapping it thereby to the appropriate task kind identification. In addition, understanding that sometimes a server process can carry out more than one task of a kind at the same time, the server tasks identification table can include, respective of each server process, the number of tasks the server is available to carry out.

According to the embodiment illustrated in FIG. 5 the server processes 501 are coupled to the server tasks manager 502, e.g., via an interface allowing inter process communication, the interface supporting registration, as was previously explained. Namely, via the interface, the server tasks manager obtains competency data pertaining to the tasks that the server can carry out. Yet, the interface can support other procedures such as notifying the server tasks manager whenever a process becomes available to accomplish a task. The interface can even be bidirectional, allowing the server tasks manager to notify the server process when a task is ready for it to accomplish.

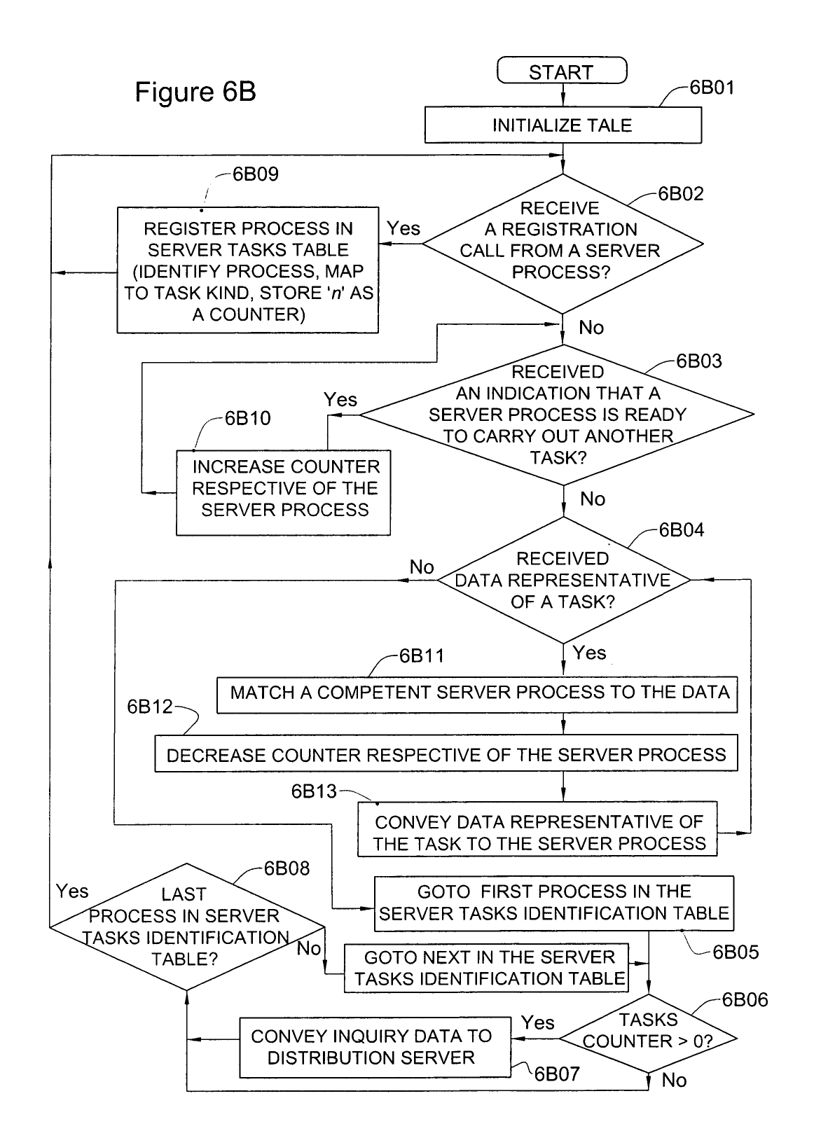

For example, in a server process competent to accomplish a task there are several (‘n’) known per se threads, with each thread being competent to carry out the task. When the server process starts operating (it is appreciated that upon startup the server process does not carry out any task), knowing the potential number of threads (‘n’), the server process notifies the server tasks manager that it is competent to carry out n tasks. According to some embodiments the server process can initially start the n threads, yet it can also start the threads upon receiving data representative of a task from the server tasks manager. In parallel, the server process can check whether any of the active threads had terminated carrying out a task, whether the thread provided an indication thereof or whether it had terminated, and if so, the server processor provides an indication to the server tasks manager that it is ready to accomplish another task of the kind. The server tasks manager and/or the server processes communicate with the distribution processor via a server agent 504. These operations of the server process are illustrated in the flow chart of FIG. 6A.

Turning now to FIG. 6B, the operations of the server tasks manager, according to one embodiment, are presented in an illustrative flowchart. It is noted that the presented server tasks manager initiates (on 6B01) an empty server tasks identification table upon startup, however, alternatives are allowed as well, such as having persistent data in the table, storing the data in a database, in which alternative upon table initialization the server tasks manager access the database and reads data therefrom. Furthermore, the presented flowchart operates in a serial mode, that is, on 6B02 it handles registration requests from server process, then, on 6B03 it handles server processes' notifications indicating that they are ready to carry out another task, on 6B04 the server tasks manager handles data items representative of tasks, and on 6B05, 6B06, 6B07 and 6B08 the server tasks manager checks whether any of the processes is ready to accomplish a task, and if so, it prepares inquiry data and sends an inquiry data item to the distribution processor.

It is to be noted that upon receiving a registration call from a server process on 6B02 the server tasks manager registers the server process in the server tasks identification table (see 6B09), including receiving the server process' predetermined identification (or determining such an identification therefore), mapping the identification to a task kind, receiving the number of tasks (‘n’) that the server can carry out at one time and storing them all in the server tasks identification table. It is to be further noted that ‘n’, when stored in the table, is used as a counter indicative of the number of tasks that the server process is ready to carry out. Then, on 6B03, upon receiving an indication that a server process is ready to carry out a task, the server tasks manager increases the counter in the table respective of the server process' identification (see 6B10), while further to 6B04, upon receiving a data item representative of a task, and matching it on 6B11 with a server process (using information store in the server tasks identification table based on task kind mapping), the counter is decreased (indicating that the server process is ready to carry out one task less) in 6B12 and the data representative of the task is conveyed on 6B13 to the server process to carry out.

When producing and conveying inquiry data to the distribution processor (see 6B05, 6B06, 6B07 and 6B08) the present server tasks manager examines all the processes listed in the server tasks indication table (see 6B05 and 6B08), and for those whose counter is greater than zero (see 6B06) inquiry data is produced and conveyed to the distribution processor. The inquiry data thus represents one server process and it can include (although this is non-mandatory) an indication to the number of tasks that the server process is ready to carry out (based on the counter). Yet, it should be appreciated that alternatives are also allowed. For example, the server tasks manager can produce one inquiry data item, indicative of all the tasks that the server is ready to carry out, that is, this inquiry data item can include data representing more than one server process and more than one task kind. A different alternative can store in the table an indication of the time in which the inquiry data was produced and/or prepared, thus avoiding sending additional inquiry data for this task kind, e.g., for a predetermined duration of time.

It was noted before that the flowchart of FIG. 6B operates in a serial mode. It is to be appreciated that this is non-limiting as well and other embodiments can operate in parallel, e.g., by using threads, hence registering server processes, handling data representative of tasks, producing and conveying inquiry data etc. at the same time. Furthermore, while conveying inquiry data items and receiving data items representative of tasks (together constituting “exchanging items”), the server tasks manager uses an agent, such as 504 in FIG. 5. However, instead of being external, the server tasks manager can be an agent, thus exchanging items directly with the distribution server, without involving an additional agent. Furthermore, understanding that an agent can operate as both server agent and client agent at the same time, hence exchanging inquiry data items, data items representative of tasks, task information items, status indication items etc., it should be appreciated that a server tasks manager and/or the agent 504 can operate as a client agent for distributing tasks from the present server 1A03 on which it is operating. In this connection, it is possible that a server process requires distribution of tasks, thus assisting it in carrying out tasks it received (via the server tasks manager) from the distribution server.

In addition, the presented embodiment is by no way limiting and other embodiments may exist for a server 1A03. For example, according to one such embodiment a server process can communicate with the distribution processor without a server tasks manager. Upon startup, or whenever resources become available thereto, the server processor can send competency and/or inquiry data to the distribution processor (via an agent) thus receiving data items representative of task information therefrom. If the agent is local to the server process (e.g., a function called thereby), the agent does not require management of server processes identity, as every item received from the distribution processor is conveyed to the single server process that the agent with whom the agent is coupled.

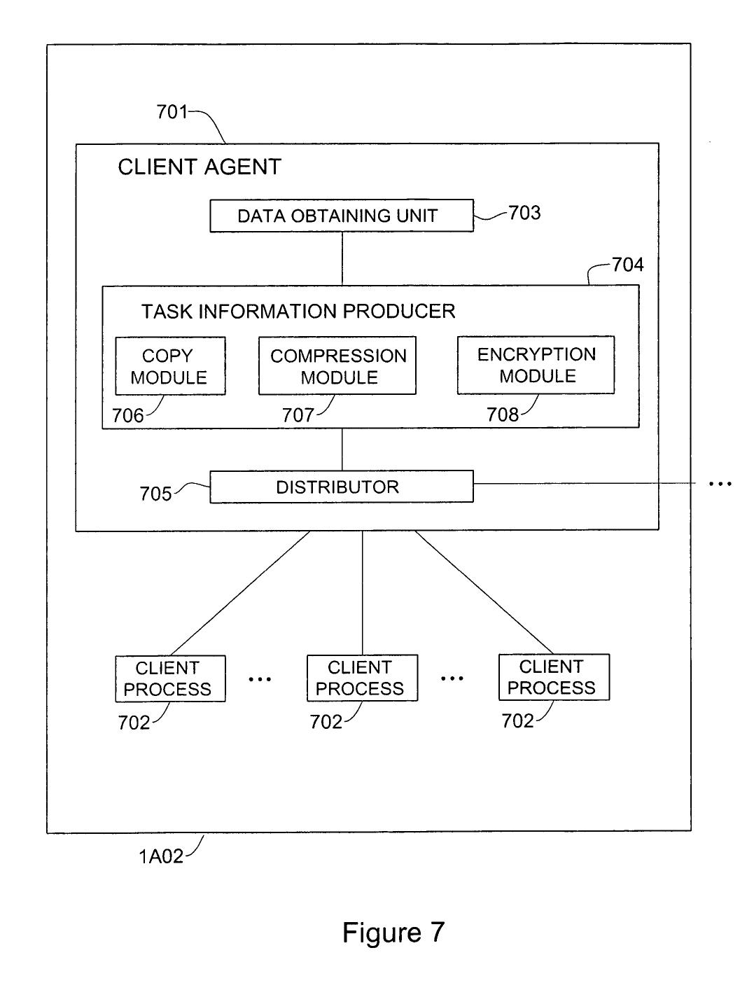

FIG. 7 is a block diagram depicting a client 1A02, according to one embodiment of the invention. The client includes a client agent 701 and one or more client processes 705 (three client processes are depicted in the block diagram, yet, the number three is non-limiting and any number can be applicable). It is noted though that according to a different embodiment the client agent can form part (or be included) in the client process. In this latter case, if several client processes are operating in the same computer, it should be understood that several client agents (one for each client process) will operate therein as well. Even further, a combination is allowed, wherein several client processes each has a client agent included therewith, while other client processes operating in the same computer might be coupled to an additional client agent such as the one illustrated in the figure.

The client agent 701 according to the embodiment includes a data obtaining unit 703, adapted to obtain data pertaining to a task from the one or more client processes 705 (see, for example, 3A01 in FIGS. 3A and 3B01, 3B02, 3B03 and 3B04 in FIG. 3B). The client agent also includes a task information producer 704 that is coupled to the data obtaining unit 703, and a distributor 705 coupled to the task information producer 704. The task information producer produces the task information stored in a task information item (e.g., see 3A02 in FIGS. 3A and 3B05 and 3B06 in FIG. 3B), while the distributor 705 conveys the task information item to a distribution processor (such as in 3A03, FIGS. 3A and 3B).

According to other embodiments the task information producer 704 includes one or more modules adapted to manipulate the data obtained by the data obtaining unit. One such illustrative embodiment includes a copy module 706 adapted to copy the data obtained by the data obtaining unit to the task information item (e.g., 3B07 in FIG. 3B). However, this is non-limiting and there may exist alternative and/or additional modules that allow manipulation of the data, such as a compression module 707 and an encryption module 708.

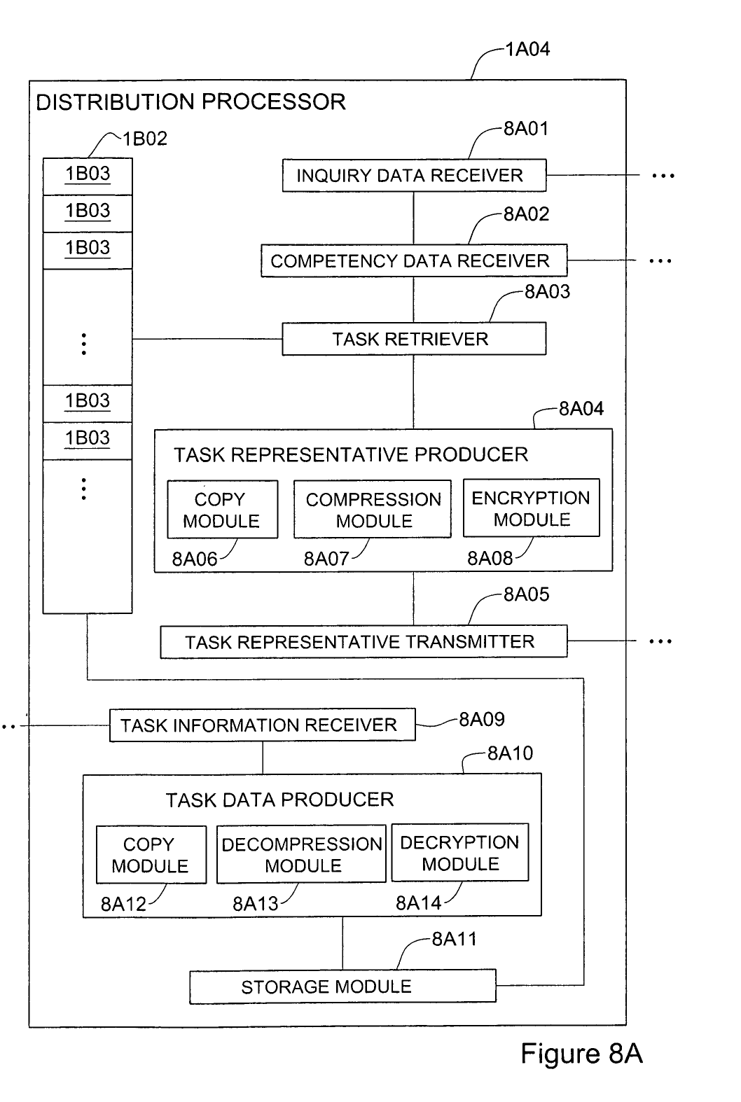

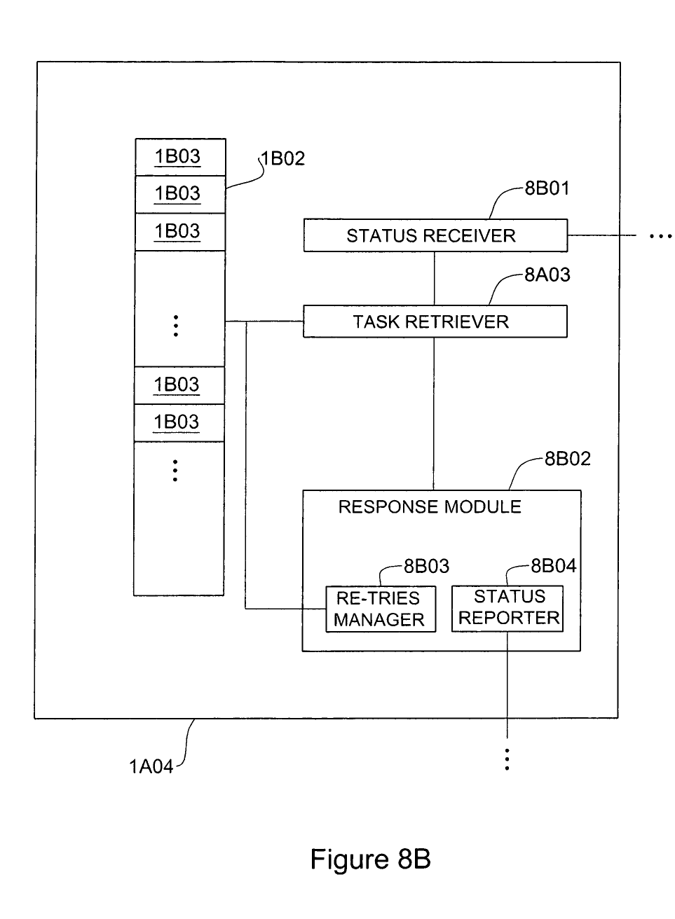

FIG. 8A is a block diagram depicting a distribution processor 1A04, according to one embodiment of the invention. As was previously explained, e.g. with reference to FIG. 1B, the distribution server includes a repository 1B02, for storing task data items 1B03. It was also explained that the distribution processor can obtain inquiry data and/or competency data from a server. Hence, the distribution processor 1A04 includes an inquiry data receiver 8A01 and a competency data receiver 8A02, wherein in accordance with some embodiments the inquiry data receiver 8A01 and the competency data receiver 8A02 can be the same.

According to the embodiment, the distribution processor includes a task retriever 8A03 coupled to the inquiry data receiver and/or to the competency data receiver, a task representative producer 8A04 coupled to the task retriever and a task representative transmitter 8A05. The task retriever has access to the repository 1B02 and to task data items 1B03 stored therein. Upon receiving inquiry data from a server (and/or competency data as was previously explained) the task retriever retrieves from the repository 1B02 task data 1B03 indicative of a task that the server is competent to perform, and the task representative producer 8A04 produces data that is representative of the task data. The task representative transmitter 8A05 then transmits the data that is representative of the task data to the server, enabling it to carry out the task.

It is noted that according to several embodiments the task data retrieved from the repository is manipulated while producing the data that is representative of the task data. In order to allow manipulation the data representative producer can include one or more manipulation modules, such as a copy module 8A06, a compression module 8A07 and an encryption module 8A08. Yet, this is non-limiting and the data representative producer 8A04 can include additional and/or alternative data manipulation modules, such as a decompression module (allowing decompression of the task data if it is compressed) and a decryption module (allowing decryption of the task data if it is encrypted).

Further according to the embodiment the distribution processor includes a task information receiver 8A09 coupled to a task data producer 8A10, in turn coupled to a storage module 8A11. The task information receiver 8A09 received task information items conveyed to the distribution processor from a client. The data producer 8A10 produces task data representative of the received task information, and the storage module 8A11 stores the task data in the repository 1B02 accessible thereto. Yet, it was noted before that the task information can be manipulated (e.g., it can be compressed or encrypted, see, for example, 707 and 708 in FIG. 7). It is thus understood that the task data producer can also include data manipulation modules that allow it to manipulate the task information while producing the task data. Examples for such data manipulation modules are a copy module 8A12 that copies the task information into the task data item, a decompression module 8A13 that can decompress the task information thus yielding an uncompressed task data and a decryption module 8A14, that can decrypt the task information if it is encrypted. Yet, this is non-limiting and the task data producer 8A10 can include additional and/or alternative data manipulation modules, such as compression and encryption modules. Even further, according to some embodiment the task representative producer 8A04 and the task data producer 8A10 can share the same data manipulation modules, for example, the copy module 8A06 and the copy module 8A11 can be the same etc.

Turning now to another embodiment of the distribution processor 1A04, whose block diagram is depicted in FIG. 8B, it is noted that the distribution processor can receive status information from servers and respond to the status information. According to the illustrated embodiment, such a distribution processor includes, in addition to the members illustrated in FIG. 8A, a status receiver 8B01 that obtains status information indicative of progress of a distributed task from the servers (see, for example, 2B01 in FIGS. 2B and 2C, 2C03 in FIG. 2C, and 4C01, 4C02 in FIG. 4C). Then, upon receiving a status information item and extracting the status information therefrom, the distribution processor retrieves from the repository the task data corresponding to the status information (such as 4C03 in FIG. 4C), wherein correspondence, in this case means that the task data is indicative of the same task which the status information is indicative thereof. It is noted that retrieving is performed, according to this specific example, by the task retriever 8A03, however, this is non-limiting and there may be a specially designed member adapted to the task. Such a member can, for example, receive the status information item from the status receiver 8B01 (which can avoid extracting the status information from the status information item), and then extract the status information from the received item (see 4C02 in FIG. 4C), including, e.g., the task identification object.

Further to retrieving the task data, it is conveyed to a response module 8B02, that responds to the status information and the task data. The response module 8B02 according to the embodiment includes a re-tries manager 8B03 and a status reporter 8B04. In those cases when the status information is indicative of failure, and if the task data and the distribution processor allow re-tries, that is, they allow re-sending data representative of the same task to another server, the re-tries manager can indicate this (e.g., mark the task data item as pending, see 4C09 in FIG. 4C, and/or even advance the task data item to the head of the queue, as indicated in 4C10, FIG. 4C). Alternatively or additionally the status reporter 8B04 can convey the status information to the client (see, e.g., 4C06 in FIG. 4C).

It will also be understood that the system according to the invention may be one or more suitably programmed computers. Likewise, the invention contemplates computer programs being readable by a computer for executing the method of the invention. The invention further contemplates a machine-readable memory tangibly embodying programs of instructions executable by the machine for executing the methods of the invention.

1. A method for distributing processing of computerized tasks from a client to one or more servers, the method comprising:
obtaining data pertaining to a task;
producing task information representative of said data; and
conveying the task information to a distribution processor adapted to distribute processing of the task to the one or more servers.

2. The method of claim 1, wherein producing includes manipulating the data pertaining to a task.

3. The method of claim 2, wherein manipulating includes at least one of copying, compressing and encrypting.

4. The method of claim 1, further including identifying a task kind respective of said task and including an identification object representative of said task kind in said task information while producing it.

5. The method of claim 1, further including waiting to receive a status information whether the task was accomplished by the one or more servers.

6. A method for distributing tasks to one or more servers, the method comprising:
obtaining from one of said one or more servers inquiry data indicative of tasks that the respective server is ready to perform;
retrieving from a repository task data indicative of a task that a specific server of said one or more servers is competent to perform;
producing data that is representative of the task data; and
conveying to the specific server the data that is representative of the task data for enabling the specific server to carry out said task.

7. The method of claim 6, wherein the inquiry data includes competency data indicative of tasks that the respective server is competent to perform.

8. The method of claim 6, further comprising:
obtaining from the one of said one or more servers competency data indicative of tasks that the respective server is competent to perform.

9. The method of claim 6, further comprising:
obtaining task information pertaining to a task to be performed by a server on behalf of a client;
producing task data that is representative of the task information; and
storing task data in said repository.

10. The method of claim 9, wherein obtaining task information includes producing the task information.

11. The method of claim 6, wherein producing the data that is representative of the task data includes manipulating the task data.

12. The method of claim 11, wherein manipulating includes at least one of copying, compressing and encrypting.

13. The method of claim 9, wherein producing the task data includes manipulating the task information.

14. The method of claim 13, wherein manipulating includes at least one of copying, decompressing and decrypting.

15. The method of claim 6, wherein further to conveying data to the one of said one or more servers the method comprising:
obtaining from the one of said one or more servers status information indicative of progress of the task;
searching in the repository task data corresponding to said task; and
further to finding said task responding to said status information.

16. The method of claim 15, wherein responding includes indicating that data representative of the task data should be conveyed to another one of said one or more servers.

17. The method of claim 15, wherein responding includes conveying data representative of the status information to a client.

18. The method of claim 9, wherein further to conveying data to the one of said one or more servers the method comprising:
obtaining from the one of said one or more servers status information indicative of progress of the task;
searching in the repository task data corresponding to said task; and
further to finding said task data responding to the status information responding to said status information.

19. The method of claim 18, wherein responding includes indicating that data representative of the task data should be conveyed to another one of said one or more servers.

20. The method of claim 18, wherein responding to the status information includes conveying data representative of the status information to the client.

21. A method for receiving data representative of tasks conveyed by a distribution processor to be carried out by a server, the method comprising:
obtaining competency data pertaining to tasks the server can carry out; and
conveying the competency data to a distribution processor for receiving data representative of a task, the data representative of a task enables the server to carry out said task.

22. The method of claim 21, wherein obtaining competency data includes generating the competency data.

23. The method of claim 21, wherein further to conveying the competency data the method comprising:
receiving the data representative of the task.

24. A client agent for distributing processing of computerized tasks from a client to one or more servers, the client agent comprising:
a data obtaining unit adapted to obtain data pertaining to a task;
a task information producer coupled to said data obtaining unit, adapted to produce task information representative of said data; and
a distributor module for conveying task information representative of said data to a distribution processor adapted to distribute processing of the task to the one or more servers.

25. The client agent of claim 24, wherein the task information producer includes at least one of a copy module, a compression module and an encryption module;
the copy module is adapted to copy the data pertaining to a task while producing the task information;
the compression module is adapted to compress data pertaining to a task while producing the task information; and
the encryption module is adapted to encrypt data pertaining to a task while producing the task information.

26. The client agent of claim 24, further comprising a status monitor adapted to receive status information, the status information being indicative whether the task was accomplished by the one or more servers.

27. A distribution processor for distributing tasks to one or more servers, the distribution processor comprising:
an inquiry data receiver adapted to obtain from one of said one or more servers inquiry data indicative of tasks that the respective server is ready to perform;
a task retriever adapted to retrieve from a repository that is adapted to store task data pertaining to various tasks to be performed by servers, task data indicative of a task that the one of said one or more servers is competent to perform;
a task representative producer adapted to produce data that is representative of the task data; and
a task representative transmitter adapted to convey to the one of said one or more servers the data that is representative of the task data for enabling the specific server to carry out said task.

28. The distribution processor of claim 27, further comprising:
a competency data receiver adapted to obtain from the one of said one or more servers competency data indicative of tasks that the respective server is competent to perform.

29. The distribution processor of claim 27, further comprising:
a task information receiver for obtaining task information pertaining to a task to be performed by a server on behalf of a client;
a task data producer coupled to said task information receiver, the task data producer is adapted to produce task data that is representative of the task information; and
a storage module for storing the task data in said repository.

30. The distribution processor of claim 27, wherein task representative producer includes at least one of a copy module, a compression module and an encryption module;
the copy module is adapted to copy the task data while producing the data that is representative of the task data;
the compression module is adapted to compress the task data while producing the data that is representative of the task data; and
the encryption module is adapted to encrypt the task data while producing the data that is representative of the task data.

31. The distribution processor of claim 29, wherein the task data producer includes at least one of a copy module, a decompression module and a decryption module;
the copy module is adapted to copy the task information while producing the task data.
the decompression module is adapted to decompress the task information while producing the task data; and
the decryption module is adapted to decrypt the task information while producing the task data.

32. The distribution processor of claim 27, further comprising:
a status receiver adapted to obtain from the one of said one or more servers status information indicative of progress of a distributed task; and
a response module coupled to the task retriever for receiving task data corresponding to the status information, the response module is adapted to respond to said status information and task data, wherein the task retriever is further adapted to retrieve from the repository the task data corresponding to the status information.

33. The distribution processor of claim 32, wherein the a response module includes a re-tries manager adapted to indicate that data representative of the task data should be conveyed to another one of said one or more servers.

34. The distribution processor of claim 32, wherein the response module includes a status reporter adapted to convey data representative of the status information to a client.

35. A server adapted to receive data representative of tasks to be carried out therein from a distribution processor and carry out the tasks, the server comprising:
a server tasks manager adapted to obtain competency data pertaining to tasks one or more server processes can carry out and generate competency data representative thereof; and
a server agent coupled to said server tasks manager, the server agent is capable to convey the competency data to a distribution processor for requesting to receive data representative of a task, the data representative of a task enables a compatible server process to carry out said task.

36. The server of claim 35, wherein the server agent is further adapted to receive data representative of a task, and wherein the server tasks manager is further adapted to convey said data representative of a task to the compatible server process.
